(19) United States
(12) Patent Application Publication
(10) Pub. No.: US 2007/0121630 A1
(43) Pub. Date: May 31, 2007

(54) METHOD AND SWITCH FOR BROADCASTING PACKETS

(75) Inventors: Routliffe Stephen, Kanata (CA); Gadelrab Serag, Kanata (CA); Roxana Christensen, Kanata (CA); Barry Wood, Dunrobin (CA)

Correspondence Address: HOGAN & HARTSON LLP, ONE TABOR CENTER, SUITE 1500, 1200 SEVENTEENTH ST, DENVER, CO, 80202, US

(73) Assignee: TUNDRA SEMICONDUCTOR CORPORATION, KANATA (CA)

(21) Appl. No.: 11/554,385

(22) Filed: Oct. 30, 2006

Related U.S. Application Data
(60) Provisional application No. 60/740,401, filed on Nov. 28, 2005.

(51) Int. Cl. H04L 12/56

(52) U.S. Cl. 370/390; 370/401

(57) ABSTRACT

A switch for broadcasting packets is provided including a plurality of input ports, a switch fabric coupled to the input ports, a plurality of output ports coupled to the suited fabrics and a multicast interconnect coupled between the input ports and output ports for routing multicast packets directly between the input and output ports. The multicast interconnect may include a multicast queue, an arbiter coupled between the multicast queue and the input ports and a plurality of broadcast buffers coupled to the multicast queue, each broadcast buffer coupled to a corresponding output port. The multicast interconnect may include a plurality of egress arbiters coupled between corresponding broadcast buffers and output ports.

### RELATED APPLICATION

The present application claims priority of U.S. Provisional Application Ser. No. 60/740,401 filed 28 Nov. 2005, which is incorporated herein in its entirety by this reference.

### FIELD OF THE INVENTION

The present invention relates to a method and switch for packets and is particularly concerned with broadcasting packets.

### BACKGROUND OF THE INVENTION

The capability to broadcast information, that is to send the same information to multiple nodes, is useful in many applications, for example:
Distribution of antenna data to multiple signal processors in a processing farm,
Distribution of computation results in a parallel computing algorithm.

Referring to FIG. 1 there is illustrated a known packet switch. The packet switch 10 includes input ports 12, a switch fabric 14 and output ports 16. An example of a packet switch is a switch compliant with RapidIO, RapidIO is a trademark of the RapidIO Trade Association, a non-profit corporation controlled by its members, directs the development and drives the adoption of the RapidIO architecture.

RapidIO has defined a standard register interface and behavior for a RapidIO switch to broadcast information, called multicast. The implementation of multicast is vendor specific. When a switch receives a packet that is to be multicast. the packet is replicated one at a time to each output port 16.

The leads to several problems. Multicasting of a packet delays all of the packets behind the packet being multicast in proportion to the size of the packet and the number of times the packet must be replicated. Congested egress ports cause head of line blocking of the multicast packet, further increasing delay. Failure of one port can block further multicast operations, and lead to congestive failure of the switch,

When a switch 10 receives a packet that is to be multicast, the ingress port 12 seizes access to all egress ports 16 and then replicates the packet in parallel to all egress ports.

This can result in the following problems:

Wastes bandwidth in the fabric 14 connecting the ports, since all ports cannot be seized simultaneously
If an egress port 16 is congested, it will cause head of line blocking of the multicast packet further increasing delay
Failure of one port can block further multicast operations, and lead to congestive failure of the switch 10.

### SUMMARY OF THE INVENTION

An object of the present invention is to provide an improved method and switch for broadcasting packets.

In accordance with an aspect of the present invention there is provided a switch for broadcasting packets comprising a switch for broadcasting packets comprising: a plurality of input ports; a switch fabric coupled to the input ports; a plurality of output ports coupled to the suited fabrics; and a multicast interconnect coupled between the input ports and output ports for routing multicast packets directly therebetween.

In accordance with another aspect of the present invention there is provided a method of broadcasting packets from an input port to a plurality of output ports comprising the steps of: at an input port, replicating broadcast packets; and directly coupling the packets to a plurality of output ports.

### BRIEF DESCRIPTION OF THE DRAWINGS

The present invention will be further understood from the following detailed description with reference to the drawings in which:

FIG. 1 illustrates an known packet switch;

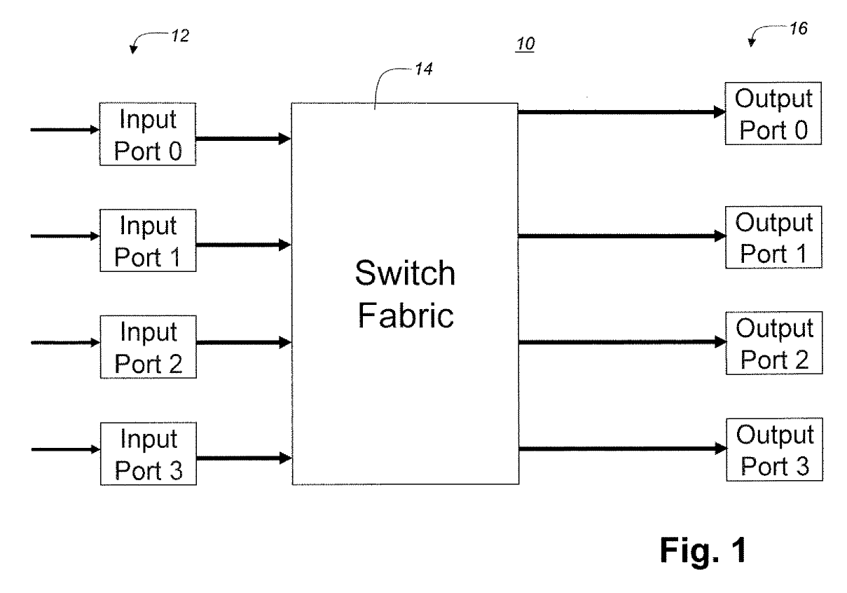

FIG. 2 illustrates a switch for broadcasting packets in accordance with a first embodiment of the present invention;

FIG. 3 illustrates a switch for broadcasting packets in accordance with a second embodiment of the present invention;

FIG. 4 illustrates a switch for broadcasting packets in accordance with a third embodiment of the present invention;

FIG. 5 illustrates a switch for broadcasting packets in accordance with a fourth embodiment of the present invention;

FIG. 6 illustrates a switch for broadcasting packets in accordance with a fifth embodiment of the present invention; and

FIG. 7 illustrates a switch for broadcasting packets in accordance with a sixth embodiment of the present invention.

### DETAILED DESCRIPTION OF THE PREFERRED EMBODIMENT

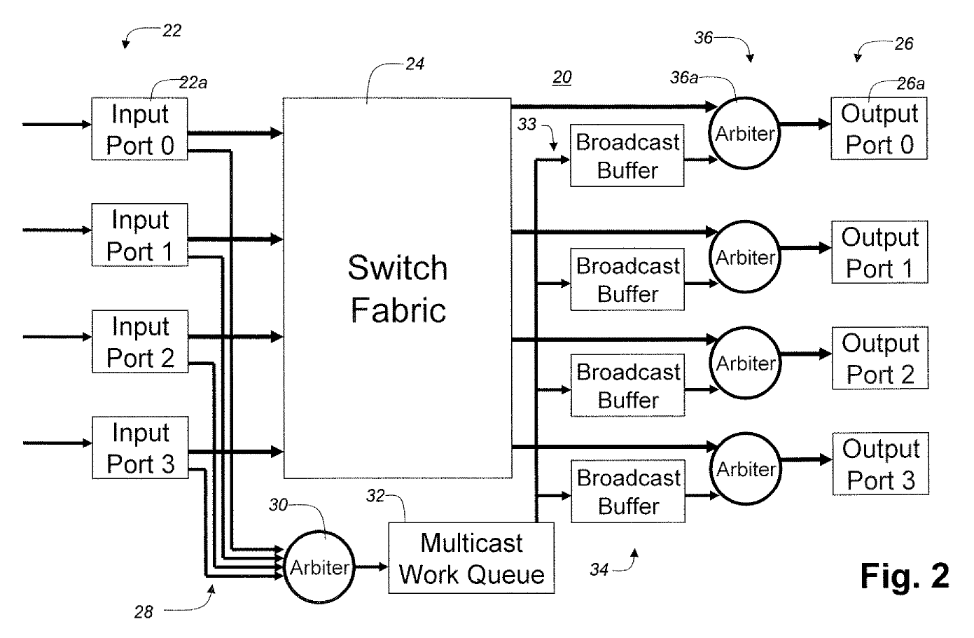

Referring to FIG. 2 there is illustrated a switch for broadcasting packets in accordance with an embodiment of the present invention. The packet switch 20 includes input ports 22, a switch fabric 24 and output ports 26. each input port 22 includes an input connection 28 for broadcast packets to a work queue arbiter 30. The arbiter 30 is coupled to a multicast work queue 32. The multicast work queue 32 is coupled in parallel via output connections 33 to broadcast buffers 34, which are coupled to output arbiters 36 and output ports 26.

In operation, the work queue arbiter 30 decides which ingress port 22 should place its packet to be multicast into the work queue 32 next. The work queue 32 holds packets that are to be multicast. This eliminates head of line blocking attributable to multicast functionality. The broadcast buffer 34 holds copies of the original packet until the egress port 26 can transmit them, The work queue 32 is connected to the broadcast buffers 34 by a dedicated interconnect. The egress port arbiter 36 implements collision resolution between multicast and non-multicast packets.

By way of example a packet to be multicast is received by Input Port 0 (22a).

The multicast work queue arbiter selects Input Port 0 (22a) as the next port from which to receive a packet. The packet is routed to the multicast work queue 32.

The multicast work queue determines which output ports 36 the packet should be sent to. The packet is replicated simultaneously to the broadcast buffers 34 of the output ports 26 selected. The broadcast buffer 34a requests to send the packet copy to the output port 26a.

For example, the egress arbiter 36 for the port 26a signals the broadcast buffer 34a to send the packet. In this way, the packet copy is transmitted on each output port.

As discussed above, delay due to size/replication time of multicast packets is a serious problem with multicast. Dedicated interconnect 28 and broadcast buffers 34 allow packet multicast to occur without interference from/to unicast traffic using the switch fabric 24. Parallel packet replication has the advantage that Multicast operations have no different performance characteristics than unicast packets.

Another problem is delay due to head of line blocking by multicast packets. A separate work queue 32 for broadcast packets means that a packet does not have to wait for a congested egress port 26 to be multicast. The egress arbiter 36 allows multicast/unicast contention to be predetermined—since multicast traffic can impact unicast traffic, or vice versa.

Failure of one output port 26 can block further multicast operations, and lead to congestive failure of the switch. Each broadcast buffer 34 has a timeout that forces forward progress of multicast data on each port. If the timeout expires, the broadcast buffer 34 is flushed, freeing up space to allow forward progress of multicast traffic.

Optionally. a port 26 whose timeout expires can be removed from future multicast operations until software can recover the affected link partner.

Multicast wastes bandwidth in the fabric connecting the ports, since all ports cannot be seized simultaneously. To overcome this problem, multicast packet replication is done separately from the non-multicast traffic, so no fabric bandwidth is wasted. The interconnect to the broadcast buffers 34 can replicate packets as quickly as they can be received from one port. The broadcast buffers 34 can accept and transmit data at the maximum fabric speeds.

The work queue arbiter and egress port arbiters can be implemented using various known arbitration algorithms, including round robin, weighted round robin, arrival time, request based, and priority based.

In accordance with a particular implementation, the RapidIO protocol, the work queue arbiter selects packets according to priority—highest priority packet offered is accepted.

Within a priority—any algorithm may be used that accepts packets from the different ports such as weighted round robin and simple round robin, etc.

The work queue 32 is a memory that holds packets waiting to be replicated. The work queue 32 uses an implementation of the RapidIO standard multicast packet replication selection register interface. An implementation specific interface that is faster and easier to use, includes the following:
The work queue 32 must choose which packet is next to be multicast
This can be First-Come-First-Serve, Last-Come-First-Serve, reordering based on strict priority, or some other algorithm.

The broadcast buffers are connected to the work queue via a dedicated interconnect. The broadcast buffers indicate whether or not they are able to accept data to the work queue 32. The work queue 32 transmits data when all of the broadcast buffers 34 that a packet must be replicated to indicate that they can accept 20 data. A variety of flow control algorithms can be used here, depending on how the broadcast buffers 34 are managed, Packets can ‘flow through’ from the input port 22, through the work queue 32, to the broadcast buffer 34 to minimize latency. A complete packet must be received by the broadcast buffer 34 before it can be transmitted on the output port 26. This is not necessary if the implementation can handle stomping of packets flowing through the work queue/broadcast buffer, and if the receiving port is at least equal in speed to the transmitting port.

The Egress port arbiter 36 allows system-specific configuration of contention between multicast and non-multicast traffic. The egress port arbiter 36 must respect strict priority ordering, that is if the multicast packet has a higher priority than the non-multicast packet, the multicast packet must be sent first. The egress port arbiter 36 can implement any arbitration algorithm e.g. round robin and weighted round robin. The particular implementation discussed is a limited form of weighted round robin (one of the two weights is restricted to 0).

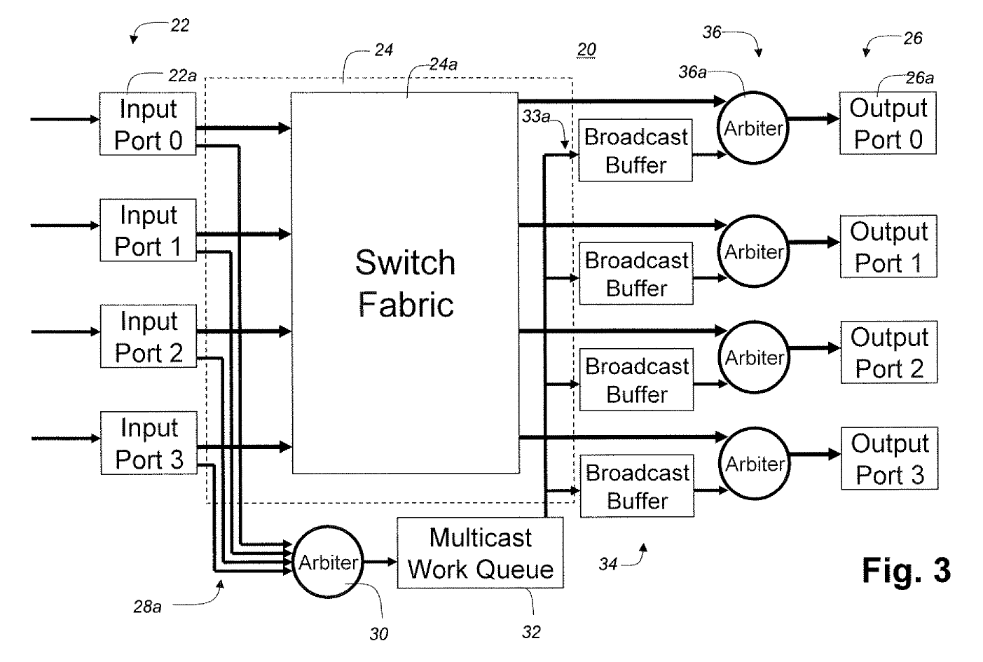

The embodiment of FIG. 2 has been simplified for illustrative purposes to show separate connections to the multicast queue. However it should be understood that various connection implementations are possible. To illustrate a few such variation FIGS. 3 through 6 are provided.

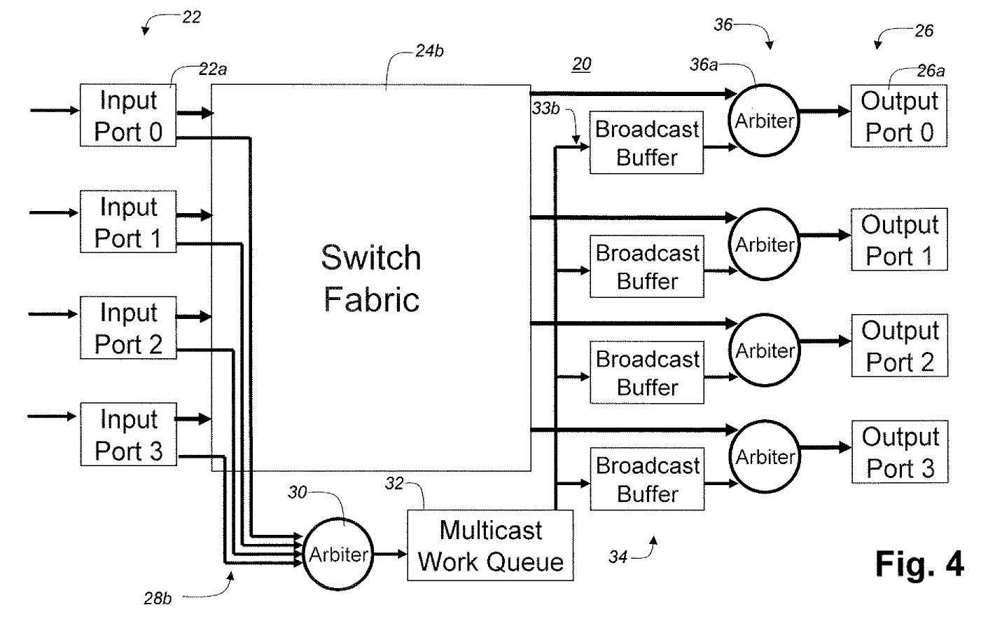

Referring to FIG. 3 there is illustrated a switch for broadcasting packets in accordance with a second embodiment of the present invention. The second embodiment shows the switch fabric 24 as extending to encompass the input connections 28 to the a work queue arbiter 30 and the output connections 33 from the multicast work queue 32 to the broadcast buffers 34. A portion 24a of the switch fabric 24 that is devoted to multi-point to multi-point connections is shown separately. As can be appreciated various combinations of switch fabric and external connection are possible without departing from the general concept. Some of these variations are illustrated in FIGS. 4 through 6.

Referring to FIG. 4 there is illustrated a switch for broadcasting packets in accordance with a third embodiment of the present invention. In FIG. 4, the switch fabric 24b is used to implement the input connections 28.

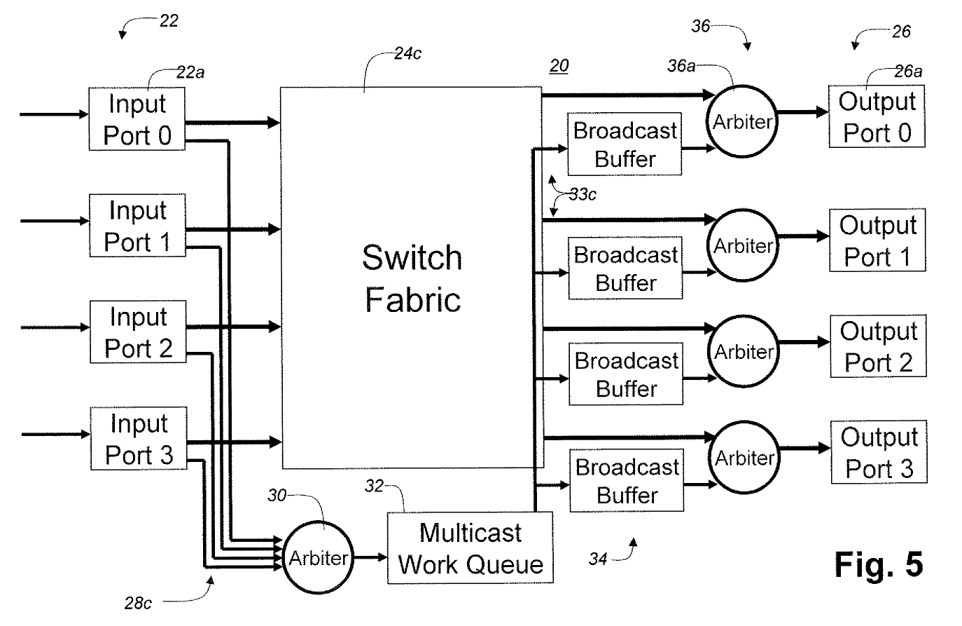

Referring to FIG. 5 there is illustrated a switch for broadcasting packets in accordance with a fourth embodiment of the present invention. In FIG. 5, the switch fabric 24c is used to implement output connections 33.

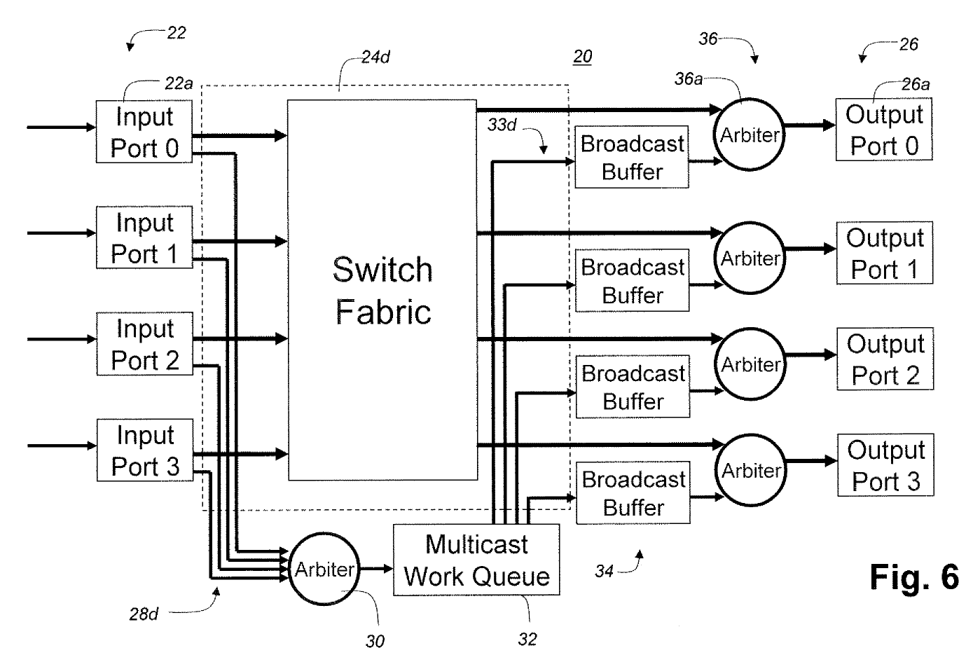

Referring to FIG. 6 there is illustrated a switch for broadcasting packets in accordance with a fifth embodiment of the present invention. In FIG. 6, the switch fabric 24d is used to implement the output connections 33a. Output connections 33a are shown at point to multipoint connections, while earlier figures were parallel or bus connections. The output connections 33 could also be parallel where delays are more acceptable.

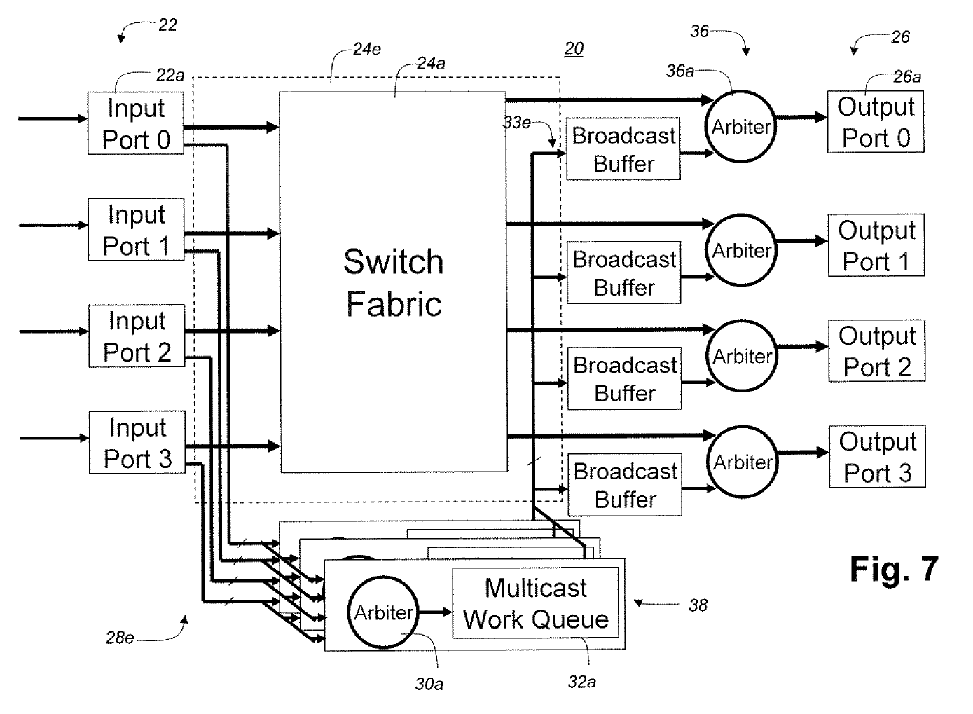

Referring to FIG. 7 there is illustrated a switch for broadcasting packets in accordance with a sixth embodiment of the present invention. In FIG. 7, the work queue arbiter and the multicast work queue are provided on multiple planes 38. The planes 38 could be used for multicasts having different priorities, for example high medium and low. In this implementation, the input connections 28e from each input port 22 has a plurality of connections corresponding to the number of priority levels. Similarly the output connections 33e provide a plurality of connections to the broadcast buffers 34. Various implementations of broadcast buffers are possible to accommodate priorities.

What is claimed is:

1. A switch for broadcasting packets comprising:
a plurality of input ports;
a switch fabric coupled to the input ports;
a plurality of output ports coupled to the suited fabrics; and
a multicast interconnect coupled between the input ports and output ports for routing multicast packets directly therebetween.

2. A switch for broadcasting packets as claimed in claim 1 wherein the multicast interconnect includes a multicast queue.

3. A switch for broadcasting packets as claimed in claim 2 wherein the multcast interconnect includes an arbiter coupled between the multicast queue and the input ports.

4. A switch for broadcasting packets as claimed in claim 2 wherein the multicast interconnect include a plurality of broadcast buffers coupled to the multicast queue, each broadcast buffer coupled to a corresponding output port.

5. A switch for broadcasting packets as claimed in claim 4 wherein the multicast interconnect includes a plurality of egress arbiters coupled between corresponding broadcast buffers and output ports.

6. A switch for broadcasting packets as claimed in claim 1 wherein the input ports include two outputs one coupled to the switch fabric and the other coupled to the multicast interconnect and a switch for switch packets between the two outputs in dependence upon packet type.

7. A switch for broadcasting packets as claimed in claim 3 wherein the arbiter includes an algorithm for resolving contention between input ports.

8. A switch for broadcasting packets as claimed in claim 7 wherein the algorithm is a round robin.

9. A switch for broadcasting packets as claimed in claim 7 wherein the algorithm is a weighted round robin.

10. A switch for broadcasting packets wherein each egress arbiter include an algorithm for resolving contention at the output ports.

11. A switch for broadcasting packets as claimed in claim 10 wherein the algorithm is a round robin.

12. A switch for broadcasting packets as claimed in claim 10 wherein the algorithm is a weighted round robin.

13. A method of broadcasting packets from an input port to a plurality of output ports comprising the steps of:
at an input port, replicating broadcast packets;
directly coupling the packets to a plurality of output ports.

14. The method as claimed in claim 13 wherein the step of replicating includes the step of identifying the packet as a broadcast packet.

15. The method as claimed in claim 13 wherein the step of replicating includes the step of arbitrating between packets from other input ports.

16. The method as claimed in claim 13 wherein the step of replicating includes the step of queuing a packet for broadcast.

17. The method as claimed in claim 13 wherein the step of replicating includes the buffering packets for output.

18. The method as claimed in claim 13 wherein the step of replicating includes the egress arbitrating broadcast packets for output.
